(19) United States
(12) Patent Application Publication
(10) Pub. No.: US 2026/0336995 A1
(43) Pub. Date: Oct. 29, 2026

(54) NARROW-AISLE INDUSTRIAL TRUCK, NARROW-AISLE RACKING SYSTEM, AND METHOD FOR OPERATING SUCH A NARROW-AISLE INDUSTRIAL TRUCK

(71) Applicant: Jungheinrich Aktiengesellschaft, Hamburg (DE)

(72) Inventor: Robert Hämmerl, Moosburg (DE)

(21) Appl. No.: 19/337,379

(22) Filed: Sep. 23, 2025

(30) Foreign Application Priority Data
Sep. 23, 2024 (EP) 24201931.3

(51) Int. Cl. B66F 9/075; B66F 9/06

(52) U.S. Cl. CPC B66F 9/0755; B66F 9/063

(57) ABSTRACT

A narrow aisle industrial truck including a vehicle body. A contour of the industrial truck can be defined in a top view, formed by the vehicle body. A front structure can extend in the longitudinal direction in front of the vehicle body. A collision protection system with a detection unit can be configured to establish a first collision protection field that extends in the longitudinal direction beyond the front structure and that has an extent in the transverse direction at least equal to the contour of the industrial truck. The collision protection system can be configured to selectively set up a second collision protection field which is shorter and wider than the first collision protection field. A narrow-aisle racking system including at least one such narrow-aisle industrial truck and a narrow-aisle rack, and a method for operating such a narrow-aisle industrial truck are further described.

### DESCRIPTION

The present invention relates to a narrow-aisle industrial truck, comprising a vehicle body with a longitudinal direction and a transverse direction, wherein a plurality of wheels are assigned to the vehicle body and, in a top view of the industrial truck, a contour of the industrial truck is formed by the vehicle body and possibly the wheels, a front structure arranged longitudinally in front of the vehicle body, and a collision protection system with at least one detection unit, which is designed to establish a first collision protection field that extends longitudinally beyond the front structure and has a transverse extent at least equal to the contour of the industrial truck. Furthermore, the invention relates to a narrow-aisle racking system, comprising at least one such narrow-aisle industrial truck and a narrow-aisle rack, as well as a method for operating such a narrow-aisle industrial truck.

Narrow-aisle racking systems are characterised by the fact that only a narrow-aisle accessible to industrial trucks is available between adjacent rack rows, making it impossible for vehicles to pass each other within these narrow-aisles. Accordingly, due to the lack of escape and evasion options, initially only the operation of a single industrial truck in a respective narrow-aisle is possible. On the other hand, the use of a collision protection system on appropriate vehicles for the safe detection of other vehicles may permit the simultaneous operation of several industrial trucks in a narrow-aisle, but they may not travel sections along the length of such a narrow-aisle where another industrial truck is already present.

In particular, such collision protection systems are designed so that, for example, by using suitable sensor units, they can detect the spatial approach of two industrial trucks to each other by establishing a so-called collision protection field, in which no foreign objects and consequently no additional industrial trucks are allowed to be present. Should the operating situation arise in which a collision protection field is violated by one of the industrial trucks during movement, automatic countermeasures can be initiated, such as decelerating a corresponding vehicle up to a complete stop.

On the other hand, such industrial trucks used in narrow-aisle racking systems often have long front structures, such as picking platforms, which extend from the respective vehicle body of such an industrial truck into the narrow-aisle. To reliably design the safety mechanism just described, the required collision protection fields must also be chosen to be sufficiently long so that they extend far enough in the longitudinal direction of the vehicle body over the corresponding front structure, ensuring that timely braking can be achieved upon detecting an obstacle or an oncoming vehicle.

Since, for example, when such an industrial truck exits a narrow-aisle, a collision protection field of this kind projects far into the marshalling area, situations can arise in which an obstacle opposite the racking, such as a wall limiting the movement area, can be detected by an appropriate detection unit before the vehicle has completely left the narrow-aisle.

To prevent this issue during the scheduled operation of such a narrow-aisle industrial truck, it has previously been necessary either to design the marshalling area of the racking relatively large, which led to a loss of usable storage space and thus to reduced efficiency of the overall facility, while on the other hand, the approach has also been pursued that drivers of a corresponding narrow-aisle industrial truck had to deactivate the collision protection system of their vehicle to leave the narrow-aisle, which on one hand increased the workload of the drivers and on the other hand brought the risk of operating errors.

Thus, there is a need here for an improved narrow-aisle industrial truck with which the operating situation described above can be better managed and through which an expansion of the marshalling area of the racking as well as an additional manual intervention in the operation of the vehicle to deactivate a collision protection system, with the associated disadvantages, can be avoided.

To address the objective formulated above and to eliminate the disadvantages of the state of the art as described above, according to the present invention, it is proposed to further develop a generic narrow-aisle industrial truck of the type described above in such a way that the collision protection system is configured to selectively set up a second collision protection field by switching, which is shorter in length and wider in width than the first collision protection field. This not only reduces the required free spacing between the rack rows and an opposing obstacle, such as especially a wall, when moving out of a narrow-aisle into a marshalling area by shortening the second collision protection field compared to the first collision protection field, but also ensures by widening the second collision protection field compared to the first collision protection field that in the case of an incorrect switch within the narrow-aisle, the respective rack rows themselves can trigger the widened second collision protection field, so that in such a case an appropriate countermeasure, especially stopping the industrial truck, can be initiated and thus a hazardous situation can be prevented.

As previously mentioned above, in a narrow-aisle industrial truck according to the invention, the front structure can be formed by a picking platform, a boom, or similar, or can include one such.

In principle, however, other types of front structures for corresponding industrial trucks are conceivable, for example, a simple height-adjustable load handling device.

Although there are initially no fundamental restrictions regarding the type and placement of the detection unit of the collision protection system on the industrial truck, as long as the two collision protection fields provided for by the invention can be suitably covered by it, it may be particularly advisable to arrange the detection unit of the collision protection system on the front side of the vehicle body in relation to its longitudinal direction.

Moreover, the collision protection system can be integrated with a central control unit of the industrial truck or operationally coupled, so that a potential breach of one of the collision protection fields can be reported to the central control unit and corresponding countermeasures can then be initiated by it. At this point, it should also be noted that an inventive narrow-aisle industrial truck can fundamentally be controlled manually as well as autonomously or semi-autonomously, since the inventive development described above can be advantageously deployed in all the aforementioned types of industrial trucks.

As also previously suggested multiple times above, the industrial truck may additionally be configured to initiate a predetermined countermeasure upon infringement of the first or second collision protection field, such as deceleration, particularly up to a complete stop; however, alternatively or additionally, other countermeasures are conceivable, such as issuing a warning to a driver operating or positioned remotely from the vehicle or to a control station operator.

Furthermore, the industrial truck can be configured to automatically switch from the first to the second collision protection field based on at least one predetermined condition, which could, for example, involve reaching a predetermined position within an operating environment, particularly corresponding to an exit from a narrow-aisle into a marshalling area.

In this context, it should also be noted that a corresponding narrow-aisle industrial truck may also include a position detection device, which is designed to detect the position of the industrial truck within its operating environment. This position detection device can also be executed in different ways, provided that the corresponding design can fulfil the operational purpose. For example, it can be connected to a system of transponders arranged in the operating environment and a corresponding receiver assigned to the vehicle, and position detection via triangulation, or to signal units arranged in the drivable ground of the operating environment, or to environmental detection using corresponding optical sensors, such as laser scanners.

According to a second aspect, the present invention relates to a narrow-aisle racking system, comprising at least one narrow-aisle industrial truck of the type just described, as well as a narrow-aisle rack, again comprising at least a pair of rack rows arranged parallel to each other at a row spacing, each comprising a plurality of rack uprights, each having an upright spacing from one another, wherein the second collision protection field of the industrial truck is at least as wide as the row spacing in width and at least as long as the largest of the upright spacings in length. In particular, all of the upright spacings can be substantially the same size, however, embodiments with variable upright spacings are also conceivable. Furthermore, variants of the invention are conceivable in which the uprights of the two rack rows are staggered relative to each other or differ in their arrangement in another way, so that to determine the largest of the upright spacings of a specific racking system with reference to the direction of extension of the narrow-aisle, uprights facing each other across the narrow-aisle may also need to be considered.

It is understood that the first collision protection field in the width direction is narrower than the row spacing, as only in this way is it possible to enable movement operation within such a narrow-aisle in the intended manner. In any case, however, it can be ensured by the dimensions of the second collision protection field just described that, in the event of an accidental switch to this during regular movement operations within a narrow-aisle, at least one rack upright will be present within the second collision protection field to violate it and thus signal the unwanted malfunction.

Herein, the spacing between the rack rows may be formed or defined by a spacing of more than the narrow-aisle between opposing pairs of rack uprights, although in principle other embodiments of racking systems are conceivable in which, for example, objects placed on the rack rows may extend further into the narrow-aisle than the rack uprights. In such a case, the widths of the first and second collision protection fields must be adjusted accordingly so that in a maximally occupied state of the racking, the first collision protection field still lies within the minimally remaining narrow-aisle, while the second collision protection field would be violated in any case in accordance with the row spacing.

As previously suggested above, the inventive narrow-aisle racking system may further include at least one aisle exit provided at one end of the rack rows, which runs substantially orthogonal to the narrow-aisle and has a marshalling area width in this direction, whereby the drivable operating environment can be particularly limited by an obstacle opposite the rack rows, especially by a wall, wherein the spacing between the rack rows and the obstacle is greater than the largest upright spacing and is referred to as the marshalling area. The marshalling area is thus the area of the warehouse located between the end of the rack and the wall opposite it, which allows the transfer of industrial trucks between the rack aisles and the transportation of goods to and from the rack aisles or racks.

Furthermore, in the system according to the invention, the industrial truck can be configured to switch from the first to the second collision protection field when exiting the narrow-aisle and especially when transitioning to the aisle exit. This switching can in particular be based on data available from the industrial truck about its own position as well as map data of its operating environment, if these indicate that an exit from a narrow-aisle is imminent. It is particularly important that the switching from the first to the second protective field only occurs when the second protective field will no longer detect the respective last rack upright of the corresponding rack rows, as switching too early could result in a breach of the protective field. Accordingly, the specific position for switching when exiting the narrow-aisle must be chosen.

In any case, the length of the second collision protection field can be chosen such that it is less than the marshalling area width.

Furthermore, the system according to the invention may also include a central warehouse management system, which is in wireless data connection with the at least one industrial truck, wherein the switching to the second collision protection field can also be carried out via the warehouse management system based on data available to it about the current operating state of the respective industrial truck. It is also evident at this point that the system described here as per the invention can include a multitude of independent industrial trucks and, for example, merely a single central warehouse management system, which guides and ensures the coordinated operation of the industrial trucks. The specific number of industrial trucks used can also vary over time and, in particular, depend on the overall size of the warehouse system.

Furthermore, the present invention relates to a method for operating a narrow-aisle industrial truck of the type just described, particularly within the framework of a corresponding narrow-aisle racking system, comprising the steps of establishing the first collision protection field while moving within the narrow-aisle and switching to the second collision protection field upon leaving the narrow-aisle. In this context, it should be noted that the additional features of the industrial truck vehicle or storage system introduced above as optional should also be understood as inventive procedural features, and accordingly, for example, the detection of the position of the industrial truck vehicle within the operating environment and the automatic switching to the second collision protection field due to the predetermined condition should also be claimed within the framework of a corresponding procedure.

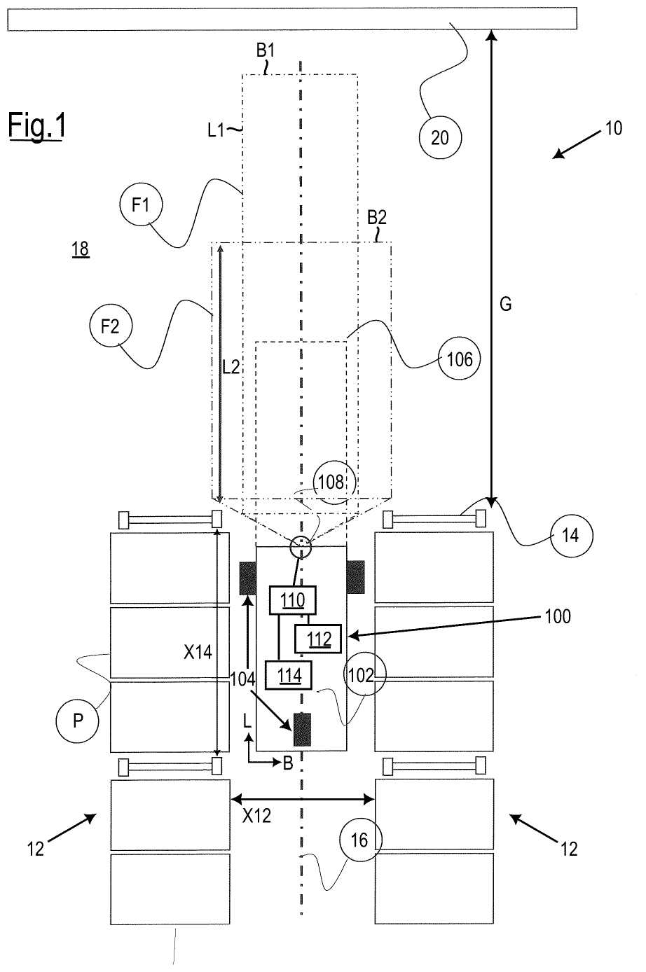

Further advantages and features of the present invention will become more apparent from the following description of an embodiment thereof when considered in conjunction with the accompanying FIG. 1. Details of the figure:

FIG. 1: a schematic top view of an inventive narrow-aisle racking system with a narrow-aisle industrial truck.

FIG. 1 now shows, in a purely schematic top view, a narrow-aisle racking system according to the invention, which is initially designated quite generally by the reference numeral 10, and of which only a pair of rack rows 12 arranged parallel to each other and also only a single narrow-aisle industrial truck 100 are shown.

The rack rows 12 are constructed in such a way that they each comprise a plurality of rack uprights 14, each of which has an even upright spacing X14 between them. At the same time, the rack rows 12 are spaced apart from each other by a row spacing X12 in such a way that a narrow-aisle 16 is formed between them, in which the industrial truck 100 described further below can move. In alternative variants of the inventive racking system 10, the spacings between uprights in the direction of extension of the narrow-aisle 16 could also be variable, wherein, for the present invention and in particular the definition of the second collision protection field explained further below, the largest spacing between uprights in this direction of extension is especially relevant, possibly also across the narrow-aisle 16 or taking into account rack uprights 14 on both sides thereof.

Furthermore, it can be seen that from the rack rows 12, a plurality of pallets P is carried, which in the construction shown here, with respect to the width of the narrow-aisle 16, protrude towards each other over the rack uprights 14, so that in the illustration from FIG. 1, they ultimately define the row spacing X12. This row spacing X12, however, could also be defined by the spacing of the rack uprights 14 perpendicular to the narrow-aisle 16 in other variants, if the pallets P do not protrude beyond these due to their design.

Furthermore, it can be seen in FIG. 1 that at the upper end of the narrow-aisle 16 shown in this depiction, or of the rack rows 12, a marshalling area 18 is connected, which in turn is bounded by a wall 20 opposite the rack rows 12. Accordingly, at the transition from the narrow-aisle 16 to the marshalling area 18, an aisle exit with a marshalling area width G for the industrial truck 100 is formed, so that it can enter or exit the narrow-aisle 12 at this point.

The industrial truck 100 itself now comprises a vehicle body 102 with a longitudinal direction L and a transverse direction B, wherein during movement within the narrow-aisle 12, the longitudinal direction L of the vehicle body 102 of the industrial truck 100 is aligned with the extension direction of the narrow-aisle 16. Furthermore, several wheels 104 are assigned to the vehicle body 102, whereby in the top view of the industrial truck 100 shown here in FIG. 1, a contour of the industrial truck 100 is formed by the vehicle body 102 and the wheels 104 protruding from it.

Furthermore, the industrial truck 100 includes a front structure 106, for example, a relatively far projecting picking platform, which extends forward in the longitudinal direction L from the vehicle body 102. Adjacent to the extension 106, a collision protection system 108 with at least one detection unit is also mounted on the front side in the longitudinal direction L of the vehicle body 102, which is designed to be able to span the two collision protection fields described below. The detection unit can, for example, be formed by a laser scanner known per se, which periodically sweeps over a detection area and is capable of detecting the presence and the spacings of objects within it.

It should be noted that the collision protection system 108 is also operationally coupled with a central control unit 110 of the industrial truck 100, which is only schematically shown here, and which in turn is coupled in a similar manner with a communication unit 112, which allows wireless communication, for example, with a central warehouse management system or a control centre of the respective logistics facility. Furthermore, the industrial truck 100 includes a position detection device 114, which is adapted to detect a position of the industrial truck 100 within its operating environment, and which also provides data to the central control unit 110.

In the normal movement operation of the industrial truck 100, the collision protection system 108 initially establishes the first collision protection field F1, which has a length L1 and a width B1. This demonstrates that, for safety reasons, the length L1 should be chosen to be relatively large, while the width B1 should at least correspond to that of the contour of the vehicle body 102 together with the protruding wheels 104.

Moreover, the illustration from FIG. 1 also shows that, before a turning manoeuvre of the industrial truck 100 would be possible upon a further exit of the industrial truck 100 from the narrow-aisle 16, the first collision protection field F1 would already be infringed by the wall 20 mentioned above. To prevent this and to keep the space requirements of the marshalling area 18 as small as possible, now in the industrial truck 100 upon exiting the narrow-aisle 12, roughly at the moment depicted in FIG. 1, a switch to the second collision protection field F2, which is also shown in FIG. 1, is made based on position and map data known to the industrial truck 100 or, for example, based on an instruction from an external central warehouse management system, through an interaction of the control unit 110 with the collision protection system 108.

It is possible in this case to switch to the second protection field F2 in the area of the aisle exit, as in the marshalling area 18, it is possible for an oncoming vehicle to evade, whereas in the narrow-aisle 16, vehicles cannot evade each other. Therefore, an appropriate anti-collision system is necessary, which must be designed for the travel of an oncoming narrow-aisle industrial truck at maximum speed and must detect it correspondingly early. Furthermore, the liftable front structure 106 of an oncoming narrow-aisle industrial truck must also be considered in the collision protection field length, as the oncoming narrow-aisle industrial truck can only be safely detected by corresponding scanners at its non-liftable structure. As in the marshalling area 18 an oncoming vehicle can or even must avoid, it is possible to switch from the very long collision protection field F1 for the narrow-aisle 16 to the shorter collision protection field F2.

The latter has a length L2, which is shorter compared to the first collision protection field F1, but an increased width B2, wherein the second length L2 is at least as large as the upright spacing X14 and the width B2 is greater than the row spacing X12. Herein, the term “rack upright spacing X14” is to be understood as the largest free spacing between adjacent rack uprights 14 in the extension direction of the narrow-aisle 16.

Furthermore, it is conceivable in this context that in another variant of an inventive racking system 10, the opposing rack rows 12 are staggered with respect to the arrangement of their rack uprights 14 or differ with respect to the respective spacings of the rack uprights 14. Accordingly, if applicable, the largest free spacing between two rack uprights 14 would be reduced with respect to the extension direction of the narrow-aisle 16, since in such a case rack uprights 14 opposite each other across the narrow-aisle 16 would be considered in terms of their spacing along the extension direction of the narrow-aisle 16. As the second protection field F2 extends beyond the rack contour on both sides as shown in FIG. 1, and the detection of a rack upright 14 on one side would be sufficient to determine a breach of the second protection field F2, opposing rack uprights 14 from the two rack rows 12 can also be used to determine the maximum upright spacing in such a variant of a racking system 10.

In any case, this thus enables, on the one hand, an exit from the narrow-aisle 12 in the area of the marshalling area 18 without the second protection field F2 being violated by the wall 20, while on the other hand, the increased width of the second protection field F2 also ensures that if there is an inadvertent switch to this during normal movement within the narrow-aisle 16, the second protection field F2 will be immediately violated on at least one side, and accordingly, appropriate countermeasures can be taken before any type of hazardous situation can occur.

1. A narrow-aisle industrial truck, comprising:
a vehicle body with a longitudinal direction and a transverse direction,
wherein a plurality of wheels is assigned to the vehicle body and, in a top view of the narrow-aisle industrial truck, a contour of the narrow-aisle industrial truck is formed by the vehicle body;
a front structure arranged longitudinally in front of the vehicle body; and
a collision protection system with at least one detection unit, which is configured to establish a first collision protection field that extends in the longitudinal direction beyond the front structure and has an extent in the transverse direction at least equal to the contour of the narrow-aisle industrial truck,
wherein the collision protection system is further configured to selectively establish a second collision protection field by switching, which is shorter in the longitudinal direction and wider in the transverse direction than the first collision protection field.

2. The narrow-aisle industrial truck according to claim 1, wherein the front structure is formed by or includes a picking platform or a boom.

3. The narrow-aisle industrial truck of claim 1, wherein the detection unit of the collision protection system is arranged on a front side of the vehicle body with reference to the longitudinal direction.

4. The narrow-aisle aisle-industrial truck of claim 1, wherein the collision protection system is integrated with or is operationally coupled to a central control unit of narrow-aisle the industrial truck.

5. The narrow-aisle industrial truck of claim 1 wherein the narrow-aisle industrial truck is configured to initiate a predetermined countermeasure upon violation of the first collision protection field or the second collision protection field.

6. The narrow-aisle industrial truck of claim 1 wherein the narrow-aisle industrial truck is configured to automatically switch from the first collision protection field to the second collision protection field based on at least one predetermined condition.

7. The narrow-aisle industrial truck of claim 1 further comprising a position detection device, which is adapted to detect a position of the narrow-aisle industrial truck within an operating environment of the narrow-aisle industrial truck.

8. A narrow-aisle racking system, comprising:
at least one narrow-aisle industrial truck comprising:
a vehicle body with a longitudinal direction and a transverse direction, wherein a plurality of wheels is assigned to the vehicle body and, in a top view of the narrow-aisle industrial truck, a contour of the narrow-aisle industrial truck is formed by the vehicle body;
a front structure arranged longitudinally in front of the vehicle body; and
a collision protection system with at least one detection unit, which is configured to establish a first collision protection field that extends in the longitudinal direction beyond the front structure and has an extent in the transverse direction at least equal to the contour of the narrow-aisle industrial truck,
wherein the collision protection system is further configured to selectively establish a second collision protection field by switching, which is shorter in the longitudinal direction and wider in the transverse direction than the first collision protection field; and
a narrow-aisle rack comprising:
a pair of parallel rack rows arranged at a row spacing from each other,
wherein each parallel rack row of the pair of parallel rack rows comprises a plurality of rack uprights, and each rack upright of the plurality of rack uprights has an upright spacing from another rack upright of the plurality of rack uprights, and
wherein each pair of parallel rack rows forms a narrow-aisle between the parallel rack rows forming the pair of parallel rack rows, wherein the second collision protection field is at least as wide as the row spacing in the transverse direction and at least as long as largest upright spacing of the plurality of upright spacings in the longitudinal direction.

9. The narrow-aisle racking system of claim 8, wherein the row spacing is formed by a spacing of pairs of rack uprights opposite over the narrow-aisle.

10. The narrow-aisle racking system of claim 8, further comprising at least one aisle exit provided at an end of the rack rows, which runs substantially orthogonal to the narrow-aisle and has a marshalling area width in this direction.

11. The narrow-aisle aisle-racking system of claim 8, wherein an operating environment of the narrow-aisle industrial truck is delimited by an obstacle opposite the rack rows, particularly a wall, wherein a spacing between the rack rows and the obstacle is greater than the largest upright spacing.

12. The narrow-aisle aisle-racking system of claim 10, wherein the narrow-aisle industrial truck is configured to switch from the first to the second collision protection field when exiting the narrow-aisle and in particular when transitioning to the aisle exit.

13. The narrow-aisle racking system of claim 10, wherein the length of the second collision protection field is less than the marshalling area width.

14. The narrow-aisle racking system of claim 8, further comprising a central warehouse management system, which is in wireless data connection with the at least one industrial truck.

15. (canceled)

16. A method comprising:
during movement within a narrow-aisle, establishing via a collision protection system comprising at least one detection unit, a first collision protection field of an industrial truck that extends in a longitudinal direction beyond a front structure of the narrow-aisle industrial truck, wherein the first collision protection field has an extent in a transverse direction of the narrow-aisle industrial truck at least equal to a contour of the narrow-aisle industrial truck; and
upon leaving the narrow-aisle, establishing via the collision protection system, a second collision protection field of the narrow-aisle industrial truck and switching from the first collision protection field to the second collision protection field, wherein the second collision protection field is shorter in the longitudinal direction and wider in the transverse direction than the first collision protection field.
